(19) United States
(12) Patent Application Publication
(10) Pub. No.: US 2007/0294543 A1
(43) Pub. Date: Dec. 20, 2007

(54) Method for reading encrypted data on an optical storage medium

(75) Inventor: Yuan-Lin Chiang, Taipei City (TW)

Correspondence Address: BIRCH STEWART KOLASCH & BIRCH, PO BOX 747, FALLS CHURCH, VA, 22040-0747, US

(73) Assignee: ARACHNOID BIOMETRICS IDENTIFICATION GROUP CORP.

(21) Appl. No.: 11/586,649

(22) Filed: Oct. 26, 2006

(30) Foreign Application Priority Data
Jun. 16, 2006 (TW) 095211804

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16

(52) U.S. Cl. 713/193; 726/27

(57) ABSTRACT

The present invention provides a method for reading encrypted data on an optical storage medium. The present invention solves the disadvantage in the prior art that a large amount of hard disk space is needed to store the decrypted data and read it through an application thereafter. The method includes the steps of: (a) passing a security verification process; (b) utilizing the encrypting/decrypting entry to decrypt the encrypted data from the optical storage medium and read it through an application. By utilizing the encrypting/decrypting entry to execute the real time encryption/decryption data file on the memory and read the decrypted data through an application thereafter, the invention does not need to temporarily store the decrypted data on the hard disk. Hence, the present invention provides the advantages of higher security and increased decryption speed.

### BACKGROUND OF THE INVENTION

1. Field of the Invention

The present invention is related to a method regarding encrypted data stored on an optical storage medium, and in particular, to a method for reading encrypted data on an optical storage medium.

2. Description of the Related Art

Encrypting/decrypting software is mainly used for encrypting/decrypting information to avoid disclosure of confidential data. The confidential data is encrypted by the encrypting/decrypting software. To read the encrypted confidential data, the encrypted confidential data must first be decrypted. Next, the decrypted confidential data is stored to a memory, such as a hard disk, and then is opened using an application, such as Microsoft Word® or Microsoft Excel® or other such application programs, for example, so that the confidential data may be read.

in the prior art, a large amount of memory (generally a hard disk) is needed for data buffering during the encryption/decryption process.

### SUMMARY OF THE INVENTION

An objective of the present invention is to provide an encrypting/decrypting entry in real-time to decrypt the encrypted data stored on an optical storage medium, and to read each data file of the encrypted data via the encrypting/decrypting entry through an application program.

To obtain this objective, the present invention provides a method for reading encrypted data on an optical storage medium. The method comprises executing a security verification process for reading encrypted data on the optical storage medium, installing an encrypting/decrypting entry in a temporary directory, and using an application program to read each data file in the encrypted data through the encrypting/decrypting entry.

The present invention installs an encrypting/decrypting entry in a temporary directory for encrypting each data file thereon, and for decrypting each data file stored on the optical storage medium in real time. The encrypting/decrypting entry takes up only a small amount of memory and the encrypted data stored on the optical storage medium is decrypted in real time.

Compared with the prior art, the present invention has two advantages. First, the present invention does not require a large amount of memory (such as a hard disk) to store the decrypted data. Second, the present invention has a security verification process. A user must pass the security verification process for the encrypting/decrypting entry in order to decrypt the encrypted data stored on the optical storage medium.

Further scope of the applicability of the present invention, will become apparent from ihe detailed description given hereinafter. However. it should be understood that the detailed description and specific examples, while indicating preferred embodiments of the invention, are given by way of illustration only, since vaarious changes and modifications within the spirit and scope of the invention will become apparent to those skilled in the art from this detailed description.

### BRIEF DESCRIPTION OF THE DRAWINGS

The present invention will become more fully understood from the following detailed description and the accompanying drawings, which are given by way of illustration only, and thus are not limitative of the present invention, and wherein:

FIG. 1 is a flow chart of a method of encrypting data on an optical storage medium of the present invention; and

FIG. 2 is a flow chart of method for reading encrypted data on an optical storage medium of the present invention.

### DETAILED DESCRIPTION OF PREFERRED EMBODIMENTS

It is understood that the disclosed embodiments apply equally to other types of optical storage mediums including, but not limited to, compact disks, and other methods of storing data on optical storage mediums.

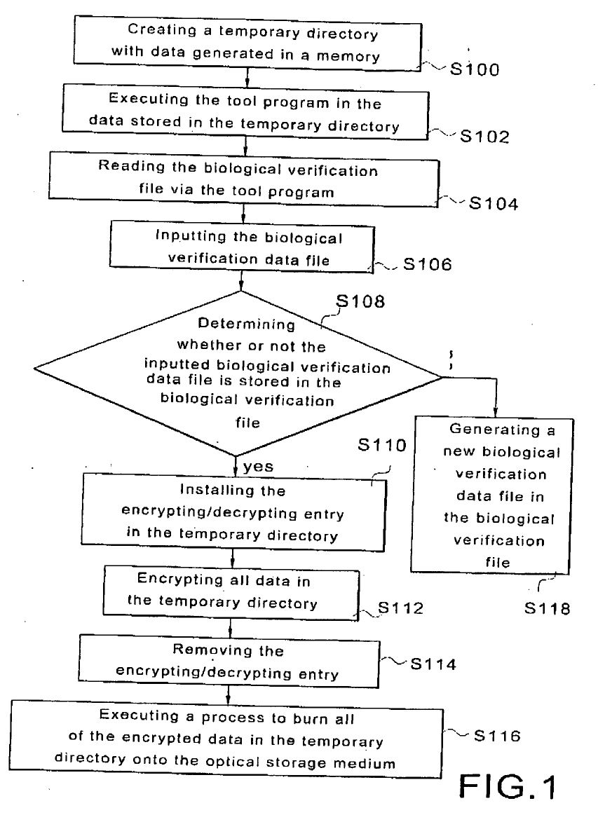

Referring to FIG. 1, a flow chart of a method of encrypting data on an optical storage medium of the present invention is shown. The method is applied to an operating process for an optical storage medium. The method includes creating a temporary directory with at least one data file generated in a memory by a user (S100). The data comprises a tool program, a biological verification file, an automatic execution program, at least one dynamic link library file of a biological verification device, and a biological data authorization file.

The tool program is executed in the data stored in the temporary directory (S102). The tool program function generates a registry data process to verify the opening process, adds/deletes the encrypting/decrypting entry, and drives the execution process. Next, the tool program reads the biological verification file (S104). The biological verification file is pre-stored in at least one biological verification data file. The user inputs a biological verification data file via the biological verification device (S106). The biological verification device may be a face verification device, a voiceprint verification device, or a fingerprint verification device. The biological verification device has a corresponding dynamic link library file stored in the temporary directory. Next, whether or not the biological verification data file is stored in the biological verification file is determined (S108). If the determining result in S108 is yes, then an encrypting/decrypting entry is installed in the temporary directory (S110). Alternatively, if the determining result in S108 is no, then a new biological verification data file in the biological verification file is generated (S118).

In S110 the encrypting/decrypting entry includes at least one encryption algorithm, such as data encryption standard or advanced encryption standard, etc. All data that is stored in the temporary directory, including any original data or new data, is encrypted via the encrypting/decrypting entry (S112). In S112 the encrypting/decrypting entry includes an encrypting and decrypting process. All data in the temporary directory or each data file inputted via an external input source, such as a fixed storage device or a removable storage device, is individually encrypted via the encrypting/decrypting entry. All encrypted data is stored in the temporary directory. Therefore, all the data in the temporary directory is encrypted. The encrypting/decrypting entry is removed once the above-mentioned process is finished (S114). A process for burning all of the encrypted data stored in the temporary directory onto an optical storage medium is then executed (S116). The burning process can be executed by any kind of burning program.

As described above in the encryption method of the present invention, the user must create a temporary directory. Next, the user executes the tool program. The tool program requests that the user input a biological verification data file via the biological verification device. It is understood that the disclosed embodiments apply equally to other types of biological verification devices including without limitation fingerprint verification devices, face verification devices, or voiceprint verification devices. The temporary directory pre-stores at least one biological verification data file of the biological verification file.

Next, the biological verification data file obtained by the user via the biological verification device is compared with the biological verification data file stored on the biological verification file. The user can use the tool program to open an encrypting/decrypting entry when the comparing result is yes. All data in the temporary directory is encrypted. The user can add new data to the temporary directory via an external input source. The new data added from the external input source is encrypted through the encrypting/decrypting entry. The user may close the encrypting/decrypting entry via the tool program when all the data has been transferred to the temporary directory. All data in the temporary directory is encrypted, so that the data shows an unrecognizable type of code. The user can then use a burning program to burn all of the data in the temporary directory onto the optical storage medium.

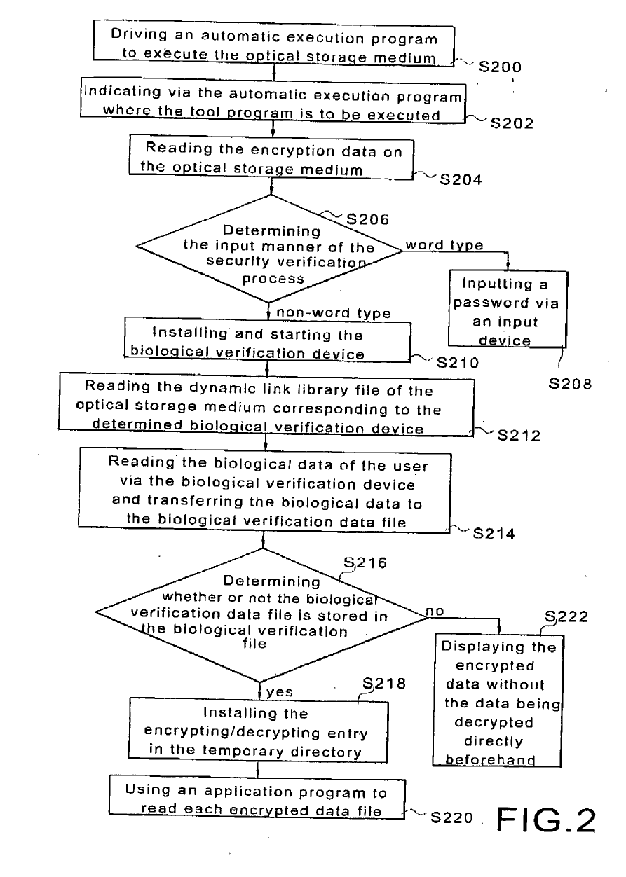

Referring to FIG. 2, a flow chart of a method for reading encrypted data on an optical storage medium of the present invention is shown. The optical storage medium includes a tool program, a biological verification file, an automatic execution program, at least one dynamic link to a library of the biological verification device, and a biological data authorization file. The encrypted data file may include at least one document file from an application program, such as a Microsoft Word® file, a Microsoft Excel® file, etc. Opening an automatic execution program executes the program stored on the optical storage medium when the optical storage medium is placed in an optical reader (S200). The automatic execution program is similar to an autorun.inf file. The automatic execution program indicates where the tool program is to be executed (S202). The tool program's functions include generating a registry data process, verifying an execution process, adding/deleting the encrypting/decrypting entry, and driving the execution process.

The tool program executes a security verification process for verifying whether the user can read the encrypted data on the optical storage medium when S202 is finished. The encrypted data file on the optical storage medium can be read when the security verification process is finished (S204). The manner of inputting the security verification process is then determined (S206). The input manner can be of a word type or a non-word type authorization. If the input manner is of a word type, then the user inputs at least one password via an input device such as a keyboard (S208). Alternatively, if the input manner is of a non-word type, then at least one biological verification device is installed and started (S210).

The driving execution process is written on the tool program and requires a small amount of memory. The automatic execution program causes the tool program to install the driving execution process to drive the biological verification device in a background of a computer system. When installation of the driving execution process is completed, the tool program creates a file similar to a driver.sys file in the operating system of the computer. The tool program determines the type of biological verification installed on the computer system, and then reads a dynamic link library file of the optical storage medium corresponding to the determined biological verification device, so as to start the biological verification device (S212). If the tool program determines that the biological verification device installed on the computer system lacks a corresponding dynamic link library file for the optical storage medium, then the computer system shows a warning window to request that the user install a driver program for the biological verification device supported by the manufacturer. The tool program reads at least one biological data of the user via the biological verification device and transfers the biological data to at least one biological verification data file (S214). The biological verification data file may be a fingerprint, a voiceprint, etc.

Whether or not the biological verification data file is stored in the biological verification file or not is then determined (S216). If the result is yes, then an encrypting/decrypting entry is installed in a temporary directory (S218). The encrypting/decrypting entry includes at least one encryption algorithm, such as data encryption standard or advanced encryption standard, etc. An application program is then used to read out each encrypted data file via an encrypting/decrypting entry (S220). After S220 has been executed the computer system can normally display the encryption data stored on the optical storage medium so that it may be viewed by the user. The encrypting/decrypting entry comprises an encrypting and decrypting process. Each data file of the temporary directory, such as text and/or graphics, must be decrypted via an encrypting/decrypting entry. The computer system can normally display each data file when decryption of each data in the temporary directory is finished.

In S216, if the determining result is no, then the encrypted data can be displayed without being decrypted directly beforehand (S222). The computer system still displays the directory and file name of the data on the optical storage medium in a normal fashion. However, the computer system shows unrecognizable types of codes rather than recognizable text and/or graphics when using the application program to open each file.

In the prior art, because the decrypted data could not be written onto an optical storage medium, the encrypted data on the optical storage medium is decrypted and stored to a memory such as a hard disk. Compared with the prior art, the present invention does not require a large external memory for storing the data. The tool program of the present invention makes an encrypting/decrypting entry for encrypting or decrypting the data on the optical storage medium. The encrypting/decrypting entry requires only a small amount of memory. The present invention does not need a large amount of memory for storing the decrypted data. The present invention executes the decryption process for the data on the optical storage medium, in real-time.

Although the present invention has been described when referring to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

1. A method for reading encrypted data on an optical medium, comprising:
executing a security verification process for reading encrypted data on the optical medium;
installing an encrypting/decrypting entry in a temporary directory; and
using an application program to read each data file of the encrypted data via the encrypting/decrypting entry.

2. The method as claimed in claim 1, wherein the optical medium includes a tool program, a biological verification file, an automatic execution program, at least one dynamic link library file of a biological verification device, and a biological data authorization file.

3. The method as claimed in claim 1, wherein the encrypted data includes at least one application program document file.

4. The method as claimed in claim 2, wherein, before the step of executing a security verification process, the automatic execution program of the optical medium is started.

5. The method as claimed in claim 4, wherein, before the step of starting the automatic execution program, the tools program of the optical medium is executed.

6. The method as claimed in claim 5, wherein the tool program generates a registry data process, verifies the execution process, adds/deletes the encrypting/decrypting entry, and drives the execution process.

7. The method as claimed in claim 1, wherein the step of executing a security verification process further comprises judging an input manner of the security verification process.

8. The method as claimed in claim 7, wherein the input manner is a word type or a non-word type authorization.

9. The method as claimed in claim 8, wherein if the input manner is the word type authorization manner, at least one password is inputted, or, if the input manner is a non-word type authorization manner, then at least one biological verification device is further installed and executed.

10. The method as claimed in claim 9, wherein the step of installing and executing at least one biological verification device further comprises determining a driving process that includes the dynamic link library file of the biological verification device.

11. The method as claimed in claim 10, wherein if a determining result is yes, then the biological verification device is executed directly, or, if the determining result is no, a driving execution process is executed to start the biological verification device.

12. The method as claimed in claim 11, wherein driving the execution process further comprises reading a biological data obtained by the biological verification device for transferring at least one biological verification data file.

13. The method as claimed in claim 12, wherein the step of reading a biological data further comprises determining if the biological verification data file includes a biological verification file.

14. The method as claimed in claim 13, wherein if the determining result is yes, then an encrypting/decrypting entry is installed on a temperature directory, or, if the determining result is no, then the encrypted data is displayed without decrypting the data file directly.
